(19) United States
(12) Patent Application Publication
(10) Pub. No.: US 2025/0262572 A1
(43) Pub. Date: Aug. 21, 2025

(54) METHODS AND APPARATUS FOR REPLACEABLE WATER FILTRATION CARTRIDGE

(71) Applicant: Zhuangyong Chen, Alpharetta, GA (US)

(72) Inventor: Zhuangyong Chen, Alpharetta, GA (US)

(21) Appl. No.: 18/442,389

(22) Filed: Feb. 15, 2024

(51) Int. Cl. B01D 29/11; B01D 35/30; B01D 39/20; C02F 1/00

(52) U.S. Cl. CPC B01D 29/114; B01D 35/30; B01D 39/2055; C02F 1/003; B01D 2201/295; B01D 2201/302; C02F 2201/006

(57) ABSTRACT

A cartridge system for filtering water according to various aspects of the present technology is configured to provide a reusable outer housing and a replaceable inner filtering element made of biodegradable materials. In one embodiment, the cartridge system comprises a multilayered filtering element configured to operate in a water pressure based filtering system. The multilayered filtering element may be configured to fit within a cushion structure disposed between the outer housing and the multilayered filtering element.

### BACKGROUND OF THE INVENTION

There are many commercial options for filtering water in residential settings. The U.S. water filter market size is increasing and reached $5.59 billion (USD) in 2020. Water filtration has become commonplace, but the current state of the technology requires constant disposal. Filter cartridges are usually made with plastic or other non-biodegradable materials, and so replacement is costly and not eco-friendly. Typical water filtration cartridges are made from materials housed within a hard plastic housing that is inserted into a water filtration system during use. After a period of time, the cartridge must be replaced to maintain the desired level of filtration and system efficiency. However, these types of cartridges are not recyclable and ultimately contribute to the continued production of waste plastics.

### SUMMARY OF THE INVENTION

A cartridge system for filtering water according to various aspects of the present technology is configured to provide a reusable outer housing and a replaceable inner filtering element made of biodegradable materials. In one embodiment, the cartridge system comprises a multilayered filtering element configured to operate in a water pressure based filtering system. The multilayered filtering element may be configured to fit within a cushion structure disposed between the outer housing and the multilayered filtering element.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a cross-sectional view of a filtration device in accordance with an exemplary embodiment of the present technology;

FIG. 2 representatively illustrates a perspective view of an outer housing of the filtration device in accordance with an exemplary embodiment of the present technology;

FIG. 3 representatively illustrates an exploded view of the filtration device in accordance with an exemplary embodiment of the present technology; and

FIG. 4 representatively illustrates a detailed view of the multi-layered filtration element in accordance with an exemplary embodiment of the present technology.

Elements and steps in the figures are illustrated for simplicity and clarity and have not necessarily been rendered according to any particular sequence. For example, components that may be coupled together in the manner shown or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of filter materials, fittings, valves, fluid conduits, and the like, which may carry out a variety of functions. In addition, the present technology may be practiced in conjunction with any number of processes such as purification of water, carbon filtration, and the system described is merely one exemplary application for the technology. Further, the present technology may employ any number of conventional techniques for removing impurities from water.

Methods and apparatus for a replaceable water filtration cartridge according to various aspects of the present technology may operate in conjunction with any suitable water delivery system, water dispensing device, and/or water treatment process. Various representative implementations of the present technology may be applied to any filtering system for treating, pressurizing, and/or storing potable or nonpotable water. For example, in one embodiment, the replaceable water filtration cartridge may be adapted to be coupled to, an existing carbon-based cartridge style filtration device used in a residential filtering system such as an under sink water filtration system or a refrigerator filtration system in place of the originally designed cartridge filter body.

The filtering system may comprise any suitable system for removing impurities in water such as salt, chlorine, and/or any other elements contained in water. For example, the filtering system may comprise a multi-stage filtration process using one or more cartridge style filters that are configured to be installed under a sink for residential use and operate at a water pressure of between 20-100 psi. In another embodiment, the filtering system may use a single cartridge style filter and be adapted for use in a residential refrigerator, beverage dispensing system, or any other filtering system utilizing a removable cartridge style filter. The filtering system may further comprise additional elements such as water lines, a storage tank for storing purified water that is not immediately needed, and a delivery device such as a faucet or other dispensing nozzle.

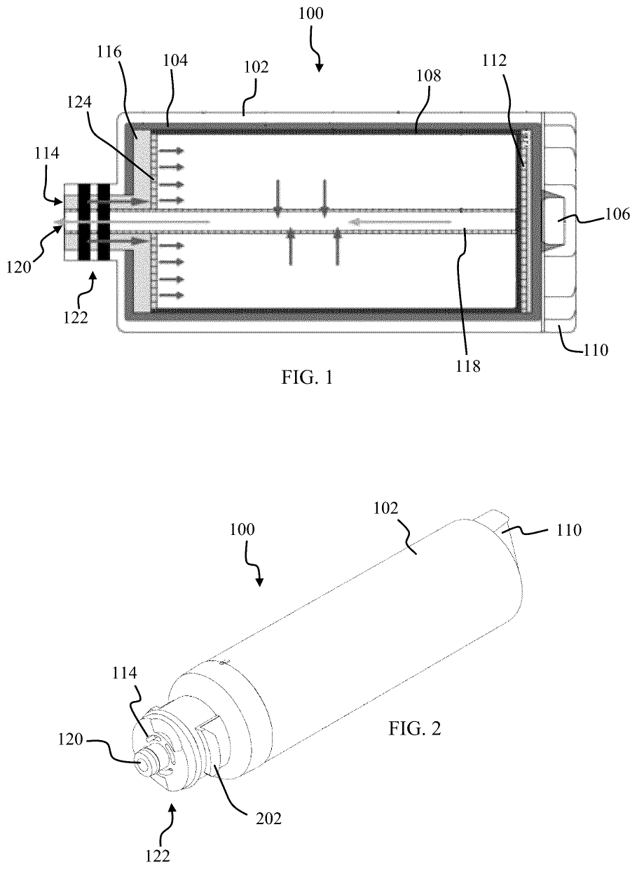

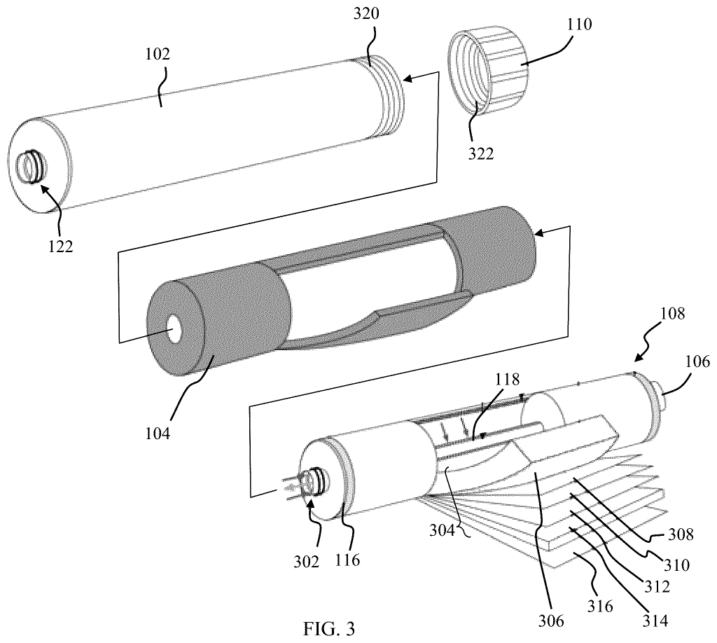

Referring now to FIGS. 1 and 2, methods and apparatus for a replaceable water filtration cartridge 100 may comprise an outer housing 102 adapted to be connected to an incoming water supply and contain a filtering device 108 within an internal volume. Unlike existing filtering cartridges, the outer housing 102 of the present technology is configured to be reusable and allow for the filtering device 108 to be removably replaced rather than the entire cartridge device.

The outer housing 102 may comprise a generally cylindrical shape of slightly larger dimensional proportions than those of the filtering device 108. The outer housing 102 may comprise a rigid body having an inlet end 122 configured to be in fluid communication with the incoming water supply and a end cap 110 disposed at an opposing second end of the outer housing 102. The end cap 110 is configured to be removable to provide access to the interior volume of the outer housing 102 so that the filtering device 108 may be inserted into and withdrawn from the interior volume.

The housing 104 may comprise any suitable material such as plastic, metal, glass, and the like. For example, in one embodiment, the housing 104 may comprise a polyvinyl composite material capable of safely being exposed to a water supply having a pH level of between 2.0 and 4.0 and flows at an operating pressure of between 20-100 psi.

The inlet end 122 may comprise one or more inlets 114 that are in fluid communication with the water supply and provide a flow path for the incoming water supply into the internal volume of the housing 104 and towards the filtering device 108. The inlet end 122 may further comprise an outlet 120 that directs filtered water to an outlet water line that directs the filtered water towards the faucet or storage tank.

The inlet end 122 may also be configured to be configured to be securely attached to a mounting system (not shown). For example, the inlet end 122 may comprise a flange 202 or retaining clip that is configured to engage the mounting system of a refrigerator to hold the filtration cartridge 100 in position during use. The flange 202 may be configured to engage the mounting system when the filtration cartridge 100 is inserted into the mounting system and rotated about its longitudinal axis. In an alternative embodiment, the inlet end 122 may comprise a threaded surface in place of the flange 202 to allow the filtration cartridge 100 to be screwed into place on the mounting system.

The end cap 110 provides a secure sealed attachment to the internal volume of the outer housing 102 and may be configured to be attached to outer housing 102 by any suitable method. The removable end cap 110 may also allow for the filtering device 108 to be removed and replaced without having to remove the entire outer housing 102 from the mounting system. For example, and with reference now to FIGS. 2 and 3, the end cap 110 may comprise a set of threads 322 positioned along an inner surface that are configured to be rotatably connected to a set of mating threads 320 disposed along an exterior surface of the outer housing 102.

The end cap 110 may also be configured to provide a water tight connection to prevent water from leaking or otherwise flowing out of the outer housing 102. For example, the end cap 110 may comprise a o-ring positioned near the set of threads 122 to prevent water from progressing along the threaded connection holding the end cap 110 to the outer housing 102.

Referring now to FIGS. 1-4, the filtering device 108 filters the incoming water supply from the inlet 114 and directs the filtered water to the outlet 120 for use. The filtering device 108 is configured to be removed from the outer housing 102 and replaced with a new filtering device 108 at the end of its life. The filtering device 108 may be comprised largely of recyclable or biodegradable materials to reduce the amount of plastic waste common with most filtering systems.

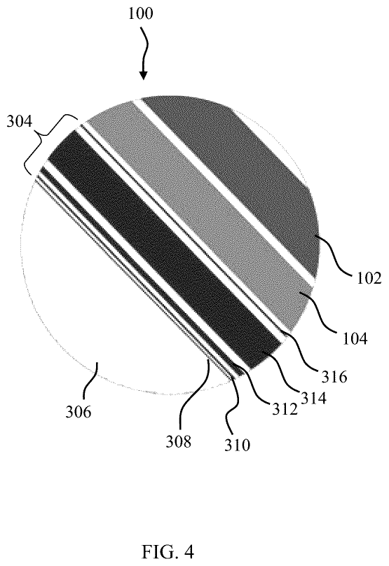

The water inlet end 122 directs the incoming water supply to a filter inlet 302 disposed on an upper filter cap 116 where the water then flows into the filtering device 108. For example, water may flow through the inlet 114 at the inlet end 122 into an inlet manifold 124 of the filter inlet 302. The inlet manifold 124 may be positioned around a portion of an outlet tube 118 proximate the filter inlet 302 and the upper filter cap 116. When subjected to a pressurized water supply, water may be forced from the inlet manifold 124 into the filtering device 108. As the incoming water supply is forced into the filtering device 108, the water may flow through a water treatment media 306 (FIGS. 3 and 4) and into the outlet tube 118. A bottom filter cap 112 may be positioned at an opposite end of the filtering device 108 as the upper filter cap 116 and be configured to prevent the incoming water supply from leaking out of the filtering device 108 so that it is forced to exit through the water treatment media 306. The bottom filter cap 116 may include a notch or handle 106 to increase the ability for the filtering device 108 to be removed from the interior volume of the outer housing 102. The water treatment media 306 may comprise any suitable device or material for filtering water. In one embodiment, the water treatment media 306 may comprise a biodegradable filtration media such as a carbon filter.

The filtering device 108 may comprise a series of intermediate layers 304 disposed between the outlet tube 118 and an outer protective shell 316. Referring now to FIGS. 3 and 4, in one embodiment, in addition to the water treatment media 306 the filtering device 108 may comprise one or more additional layers for keeping the water flow contained within the filtering device 108 and directed towards the outlet tube 118. The additional layers may also be directed at making the filtering device 108 airtight and structurally sound when exposed to the water flow and associated pressures. For example, immediately adjacent to the water treatment media 306 may be positioned a rigid shell 308 for resisting water pressure and to protect additional inner layers. The rigid shell 308 may comprise any suitable material capable of resisting outward directed pressures applied by the water supply when flowing through the water treatment media 306.

A first watertight layer 310 may be located on the opposing side of the rigid shell 308 from the water treatment media 306. The first watertight layer 310 may comprise any suitable material for reducing or eliminating the ability for water to flow outwardly towards the outer protective shell 316. In one embodiment, the first watertight layer 310 may comprise a polypropylene material. In alternative embodiments, the first watertight layer 310 may comprise any other material that is configured to be nonporous to prevent the outward flow of water.

In some embodiments, a second watertight layer 312 may be positioned adjacent to the first watertight layer 310. The second watertight layer 312 may provide a redundant or backup layer of protection in the event that the first watertight layer 310 is compromised. Similar to the first watertight layer 310, the second watertight layer 312 may comprise any suitable material for providing a watertight seal. In one embodiment, the second watertight layer 312 may be comprised of an aluminum foil layer.

Positioned outward from the second watertight layer 312 may be a structural layer 314 directed towards providing increased structural durability against the internal water pressure. For example, in one embodiment the structural layer 314 may comprise a paper-based filler configured to provide some cushioning against internal pressure changes. The paper-based filler may be configured to be slightly compressible in response to increases in pressure to allow the filtering device 108 to function properly despite pressure surges. The structural layer 314 may also better distribute any internal pressure across an inner surface of the outer protective shell 116. The structural layer 314 may comprise any other suitable material or device for providing increased strength to the filtering device 108 during use.

The outer protective shell 316 may be positioned immediately outward of the structural layer 314. The outer protective shell 316 may comprise a nonporous material such as a PEX membrane or tube configured to protect the internal components of the filtering device 108 and withstand the operational pressures experienced by the water treatment media 306 and the intermediate layers 304 while also providing a somewhat soft and flexible exterior surface. The outer protective shell 316 helps maintain the watertightness of the filtering device 108. The PEX membrane may also provide additional protection against the operating pressures of the filtering device 108.

For example, the filtration cartridge 100 may further comprise a water treatment media 306. The cushioning layer 104 may be disposed between the outer protective shell 316 and the outer housing 102 and be configured to absorb pressures from the outer protective shell 316. The cushioning layer 104 may comprise any suitable device for providing additional pressure absorption such as a compressible foam, neoprene rubber, or the like. For example, in one embodiment, the water treatment media 306 may comprise a sleeve configured to receive the filtering device 108 within an open interior. The sleeve and filtering device 108 may then be inserted into the outer housing 102 and locked into place with the end cap 110. The cushioning layer 104 may be configured to be reusable or be replaceable at the same time as the filtering device 108.

The technology has been described with reference to specific exemplary embodiments. Various modifications and changes, however, may be made without departing from the scope of the present technology. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises,” “comprising,” or any variation thereof, are intended to reference a non-exclusive inclusion, such that a process, method, article, composition or apparatus that comprises a list of elements does not include only those elements recited but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same. Any terms of degree such as “substantially,” “about,” and “approximate” as used herein mean a reasonable amount of deviation of the modified term such that the end result is not significantly changed. For example, these terms can be construed as including a deviation of at least ±5% of the modified term if this deviation would not negate the meaning of the word it modifies.

The present technology has been described above with reference to a preferred embodiment. However, changes and modifications may be made to the preferred embodiment without departing from the scope of the present invention. These and other changes or modifications are intended to be included within the scope of the present technology, as expressed in the following claims.

1. A filter cartridge and replaceable filter, comprising:
an outer housing comprising:
a generally cylindrical main body section;
an inlet end configured to attach the outer housing to an incoming water supply, wherein the first end includes a first inlet and a first outlet;
a removable end cap connectable to a second end of the main body section;
a generally cylindrical filter element configured to be removably inserted into an interior portion of the main body section, wherein the filter element comprises:
a filter inlet in fluid communication with the first inlet;
a filter outlet in fluid communication with the first outlet; and
a nonporous exterior surface;
a cylindrical cushioning sleeve positioned within the interior portion of the main body section between the nonporous exterior surface of the filter element and an inner surface of the main body section.

2. A filter cartridge and replaceable filter according to claim 1, wherein the filter element further comprises:
a generally cylindrical filter shell;
an upper filter cap disposed at a first end of the filter shell and incorporating the filter inlet;
a bottom filter cap disposed at an opposite second end of the filter shell;
an outlet tube extending between the upper filter cap and the bottom filter cap and in fluid communication with the filter outlet; and
a water treatment media wrapping around the outlet tube and extending between the upper filter cap and the bottom filter cap.

3. A filter cartridge and replaceable filter according to claim 2, wherein the wherein the filter element further comprises a multilayered material disposed between the water treatment media and the nonporous exterior surface of the filter element.

4. A filter cartridge and replaceable filter according to claim 3, wherein the multilayered material comprises:
a shell disposed adjacent to an opposite side of the water treatment media as the outlet tube;
a first watertight layer disposed adjacent to an opposite side of the shell as the water treatment media;
a second watertight layer disposed adjacent to an opposite side of the first water treatment as the shell; and
a structural layer disposed between the second watertight layer and the nonporous exterior surface of the filter element.

5. A filter cartridge and replaceable filter according to claim 4, wherein the structural layer comprises a paper material.

6. A filter cartridge and replaceable filter according to claim 1, wherein the nonporous exterior surface comprises a PEX membrane.

7. A filter cartridge and replaceable filter according to claim 1, wherein the cushioning sleeve fully encloses the filter element.

8. A replaceable filter for a cartridge filter housing, comprising:
a generally cylindrical filter element configured to be removably inserted into an interior portion of the main body section, wherein the filter element comprises:
a filter inlet in fluid communication with the first inlet;
a filter outlet in fluid communication with the first outlet; and
a nonporous exterior surface.

9. A replaceable filter for a cartridge filter housing according to claim 8, wherein the filter element further comprises:
a generally cylindrical filter shell;
an upper filter cap disposed at a first end of the filter shell and incorporating the filter inlet;
a bottom filter cap disposed at an opposite second end of the filter shell;
an outlet tube extending between the upper filter cap and the bottom filter cap and in fluid communication with the filter outlet; and
a water treatment media wrapping around the outlet tube and extending between the upper filter cap and the bottom filter cap.

10. A replaceable filter for a cartridge filter housing according to claim 9, wherein the water treatment media comprises a biodegradable material.

11. A filter cartridge and replaceable filter according to claim 9, wherein the wherein the filter element further comprises a multilayered material disposed between the water treatment media and the nonporous exterior surface of the filter element.

12. A filter cartridge and replaceable filter according to claim 11, wherein the multilayered material comprises:
a shell disposed adjacent to an opposite side of the water treatment media as the outlet tube;
a first watertight layer disposed adjacent to an opposite side of the shell as the water treatment media;
a second watertight layer disposed adjacent to an opposite side of the first water treatment as the shell; and
a structural layer disposed between the second watertight layer and the nonporous exterior surface of the filter element.

13. A filter cartridge and replaceable filter according to claim 12, wherein the structural layer comprises a paper material.

14. A filter cartridge and replaceable filter according to claim 8, wherein the nonporous exterior surface comprises a PEX membrane.
